(19) United States
(12) Patent Application Publication
(10) Pub. No.: US 2015/0081814 A1
(43) Pub. Date: Mar. 19, 2015

(54) WEB REPLY PATH VIA SMS

(71) Applicant: Talk.to FZC, Ras Al Khaimah (AE)

(72) Inventor: Bhavin Turakhia, Mumbai (IN)

(73) Assignee: Talk.to FZC, Ras Al Khaimah (AE)

(21) Appl. No.: 14/295,103

(22) Filed: Jun. 3, 2014

(30) Foreign Application Priority Data
Sep. 18, 2013 (IN) 3014/MUM/2013

(51) Int. Cl. H04L 12/58

(52) U.S. Cl. CPC H04L 51/046
USPC 709/206

(57) ABSTRACT

Methods and systems of providing a web reply path via an SMS-based communication are disclosed. A request to send an SMS message to a second user may be received from a first user. A first SMS message may be sent to the second user via SMS-based communication in response to the request from the first user. The first SMS message may comprise a URL. In response to the second user causing the URL to be loaded on a web browser, a web-based chat session between the first user and the second user may be initiated using the URL. The first user and the second user may be enabled to send chat messages to each other via the web-based chat session, which may be hosted by an online service provider at the URL.

### CROSS-REFERENCE TO RELATED APPLICATION(S)

The present application claims the benefit of priority under 35 U.S.C. §119 to Indian Application No. 3014/MUM/2013, filed on Sep. 18, 2013, which is incorporated herein by reference in its entirety.

### TECHNICAL FIELD

The present application relates generally to the technical field of data processing, and, in various embodiments, to methods and systems of providing a web reply path via a short message service (SMS) communication.

### BACKGROUND

SMS-based communication allows users to exchange short text messages between mobile devices. However, the sending and receiving of SMS messages can result in significant fees for users. Additionally, SMS messages can be limited in their functionality when compared to other types of electronic communication.

### BRIEF DESCRIPTION OF THE DRAWINGS

Some embodiments of the present disclosure are illustrated by way of example and not limitation in the figures of the accompanying drawings, in which like reference numbers indicate similar elements, and in which:

FIGS. 1A-1E illustrate different stages of providing a web reply path via SMS-based communication, in accordance with some embodiments;

FIG. 2A is a block diagram illustrating a reply path system, in accordance with some embodiments;

FIG. 2B is a block diagram illustrating a reply path system, in accordance with some embodiments;

FIG. 3 illustrates a user interface for a web-based chat session in accordance with some embodiments;

FIG. 4 is a flowchart illustrating a method of providing a web reply path via SMS-based communication, in accordance with some embodiments;

FIG. 5 is a flowchart illustrating a method of switching between SMS-based communication and a web-based chat session, in accordance with some embodiments;

FIG. 6 is a flowchart illustrating another method of switching between SMS-based communication and a web-based chat session, in accordance with some embodiments; and

FIG. 7 shows a diagrammatic representation of a machine in the example form of a computer system within which a set of instructions may be executed to cause the machine to perform any one or more of the methodologies discussed herein, in accordance with some embodiments.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques are not shown in detail.

Example methods and systems are directed to providing a web reply path via a short message service (SMS) communication. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

In some embodiments, a method may comprise receiving, from a first user on a first device, a request to send a short message service (SMS) message to a second user on a second device, and sending a first SMS message to the second user on the second device via SMS-based communication in response to the request from the first user. The first SMS message may comprise a uniform resource locator (URL). In response to the second user causing the URL to be loaded on a web browser on the second device, a web-based chat session between the first user on the first device and the second user on the second device may be initiated using the URL. The first user and the second user may be enabled to send chat messages to each other via the web-based chat session using the first device and the second device (or some other device of the second user), respectively. The web-based chat session may be hosted by an online service provider at the URL. In some embodiments, the second user may cause the URL to be loaded by selecting a link to the URL in the first SMS message or by entering the URL into the web browser on the second device, or on some other device of the second user. The first user may participate in this web-based chat session via an application on his or her device, while the second user may participate in this web-based chat session via the URL loaded on the web browser on his or her device.

In some embodiments, if it is determined that the most recent message from the second user to the first user was sent via SMS-based communication, then a first next message from the first user to the second user may be configured to be transmitted via SMS-based communication. In some embodiments, if it is determined that the second user visited the URL, then a second next message from the first user to the second user may be configured to be transmitted via the web-based chat session. In some embodiments, it may be determined that the second user has not read a web chat message transmitted via the web-based chat session based on a confirmation packet not being sent by the second user device via the web chat session within a predetermined amount of time, and a repeat message may automatically be sent via SMS-based communication to the second user in response to the determination that the second user has not read the web chat message. In some embodiments, the repeat message may comprise a copy of the web chat message.

The first user may provide the request to send the SMS message to the second user using a mobile application installed on the first device. The mobile application may provide a user interface for sending the first SMS message to the second user and for sending and receiving the chat messages of the web-based chat session with the second user. In some embodiments, a second SMS message from the second user may be received as a reply to the first SMS message from the first user. The second SMS message may be displayed to the first user via the user interface of the mobile application on the first device. A third SMS message may be created via the user interface of the mobile application on the first device. The third SMS message may be sent to the second user via SMS-based communication. In some embodiments, the mobile application may send a copy of all SMS messages sent and received by the first user to the online service provider. In some embodiments, a history of all of the SMS messages and chat messages sent and received by the first user via the user interface of the mobile application may be caused to be displayed to the second user via the URL.

In some embodiments, in response to receiving the request from the first user, a session token configured to represent the second user may be created or received. The session token may be included in the URL in the first SMS message, and may be used to initiate the web-based chat session between the first user and the second user. In some embodiments, the first SMS message may be sent to the second user via a wireless carrier used by the first user or an SMS gateway of the online service provider.

In some embodiments, an account for the second user with the online service provider may be automatically created in response to the second user causing the URL to be loaded on the web browser. In some embodiments, automatically creating the account for the second user may comprise obtaining the second user's name from an electronic address book of the first user. In some embodiments, the first SMS message may be sent to a mobile phone number of the second user, and automatically creating the account for the second user may comprise using the mobile phone number of the second user in creating the account for the second user.

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to perform the instructions.

The system and features of the present disclosure may be employed using a client-server architecture, but are not limited to such an architecture, and could also find application in a distributed, or peer-to-peer, architecture system, for example.

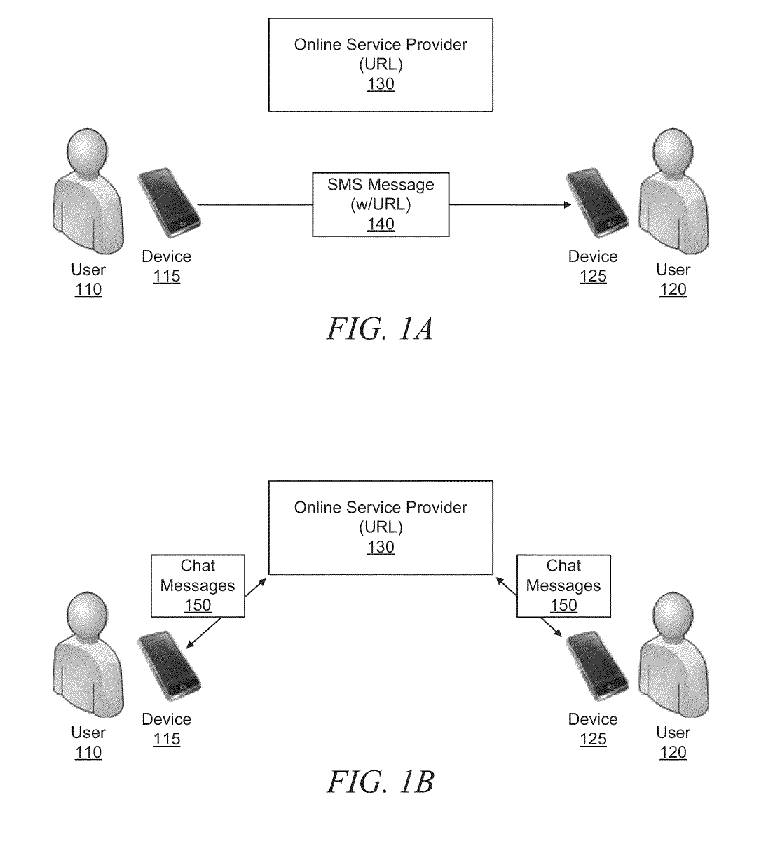

FIGS. 1A-1E illustrate different stages of providing a web reply path via SMS-based communication, in accordance with some embodiments. In this example, messages are exchanged between a first user 110 on a first communication device 115 and a second user 120 on a second communication device 125. It is contemplated that messages may be exchanged as disclosed herein between any number and combination of users and devices.

The term “communication device” is used herein to refer to any device capable of sending and receiving a communication from another device. The communication device may be configured to use one or more services that provide communication functionality (e.g., communication services). For example, a communication device may be connected to a network (e.g., a wired network, a wireless network, or both), and the communication device may be configured (e.g., by software, hardware, or both) to communicate (e.g., send, receive, or both) messages via the network according to one or more communications protocols supported by one or more services (e.g., communication services). Examples of such services include, but are not limited to, telephony services (e.g., analog or digital voice telephony services, including Voice over IP (VoIP) services), instant messaging (IM) services (e.g., text-based chat services, including Internet chat services), text messaging services (e.g., short message services (SMS)), video conference services (e.g., analog or digital video phone services, including webcam-based services supporting video, audio, or both), and any suitable combination thereof. Examples of communication devices include, but are not limited to, a mobile phone, a tablet computer, a laptop computer, and a desktop computer.

In some embodiments, the SMS messages and chat messages disclosed herein may be sent via one or more networks. The one or more networks may comprise any network that enables the corresponding type of communication (e.g., SMS messages, chat messages) between or among machines, databases, and devices. Accordingly, the one or more networks may include, but are not limited to, a wired network, a wireless network (e.g., a mobile or cellular network), or any suitable combination thereof. The one or more networks may include one or more portions that constitute a private network, a public network (e.g., the Internet), or any suitable combination thereof.

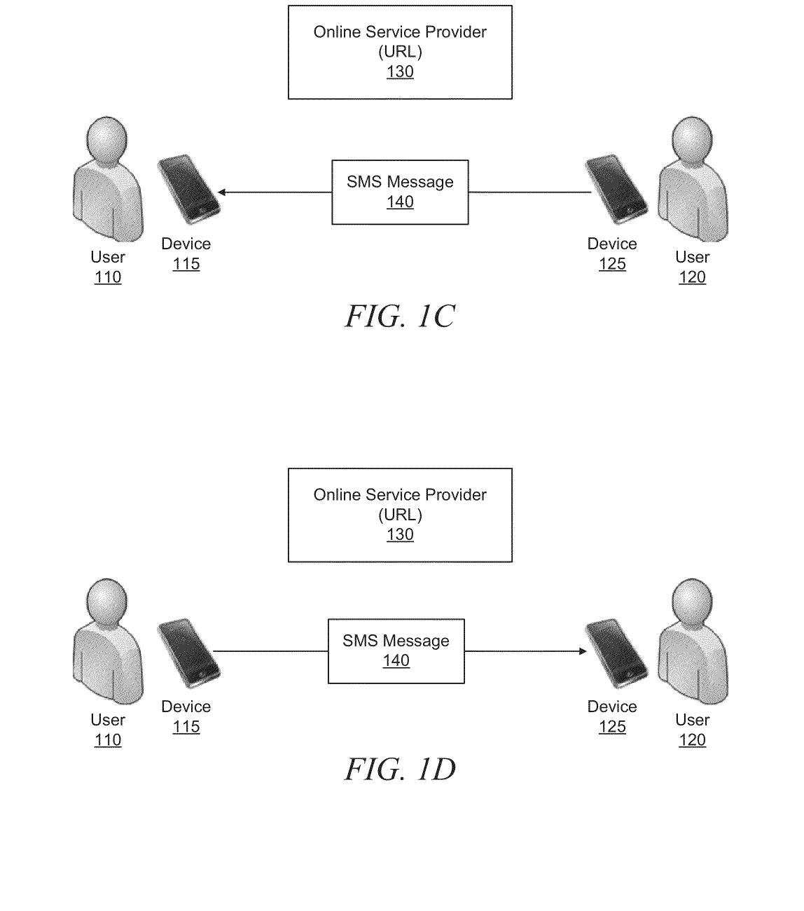

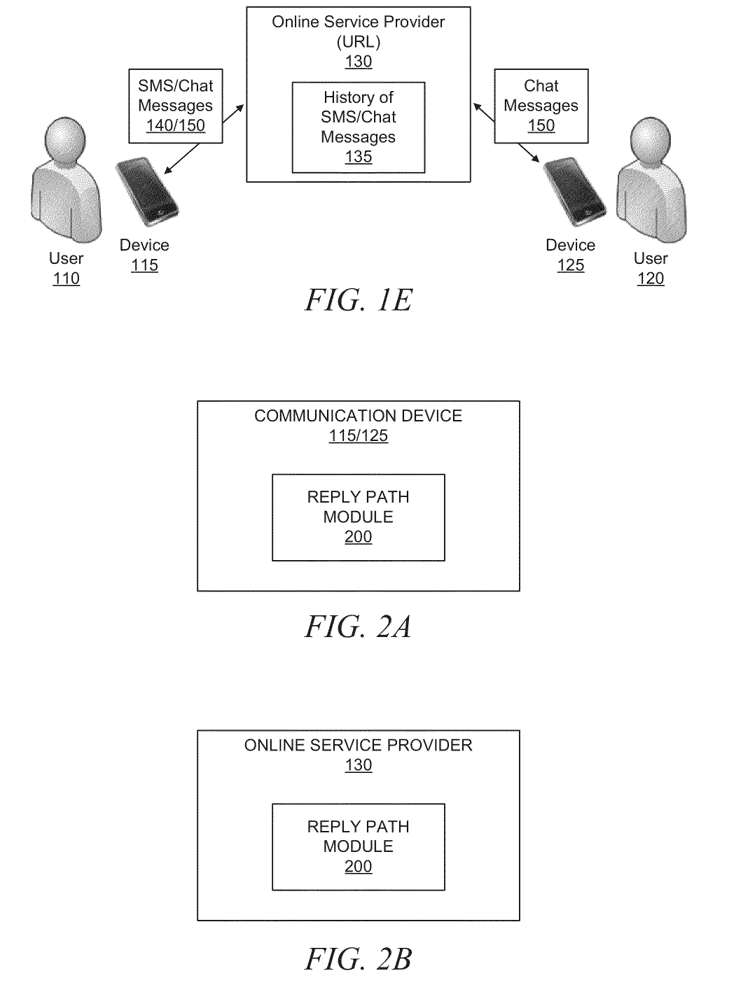

Referring to FIG. 1A, the first user 110 on the first communication device 115 may request that an SMS message be sent to the second user 120 on the second communication device 125. In some embodiments, this request may be submitted via an application (e.g., a mobile app) installed on the first communication device 115. The application may be issued by and correspond to an online service provider 130, with which the first user 110 may have an account. In some embodiments, the online service provider 130 may be a company that provides text messaging service and/or web-based chat service to users. The features and operations disclosed herein may be implemented and performed by a reply path module 200, which may reside on the first communication device 115 and/or on the second communication device, as shown in FIG. 2A, and/or on the online service provider 130, as shown in FIG. 2B. Other configurations are also within the scope of the present disclosure.

In response to the request by the first user 110, an SMS message 140 may be sent to the second user 120 on the second device 125. In some embodiments, the SMS message 140 may be sent to the second user 120 via a wireless carrier used by the first user 110 or via an SMS gateway of the online service provider 130. The SMS message 140 may comprise a URL. In some embodiments, a unique session token may be included in the URL (e.g., at the end of the URL). The session token may be configured to represent the second user 120 or both the first user 110 and the second user 120. In some embodiments, the session token may be created by the application installed on the first communication device 115 and then included in the SMS message 140 to the second user 120. In some embodiments, the session token may be created by the online service provider 130, and then sent to the application installed on the first communication device 115, where it can be included in the SMS message 140. In some embodiments, the session token may be created by the online service provider 130, and then included in the SMS message 140 at the online service provider 130, in embodiments where the SMS message 140 from the first user 110 is routed through the online service provider 130 on its way to the second user 120. It is contemplated that other methods and configurations of including the session token into the SMS message 140 are also within the scope of the present disclosure.

The SMS message 140 from the first user 110 to the second user 120 may include an indication to the second user 120 to reply via the URL (e.g., a message that reads “Reply via http://talk.to/<token>”). After receiving the SMS message 140, the second user 120 may cause the URL in the SMS message 140 to be loaded on a web browser on the second communication device 125. In some embodiments, the second user 120 may cause the URL to be loaded on the web browser by selecting a link to the URL in the SMS message 140 or by entering the URL into a web browser (e.g., a web browser on the second communication device 125 or on some other device of the second user 120).

Referring to FIG. 1B, in response to the second user 120 causing the URL to be loaded on the web browser, a web-based chat session between the mobile application being used by the first user 110 on the first communication device 115 and the web browser being used by the second user 120 on the second communication device 125 (or some other device) may be initiated using the URL. The web-based chat session may be hosted by an online service provider 130 at the URL. The online service provider 130 may use the session token to authenticate the identity of the second user 120, and thereby to authenticate the web-based chat session. The first user 110 and the second user 120 may then be enabled to send chat messages 150 to each other via the web-based chat session using their respective communication devices 115, 125.

In some embodiments, if the second user 120 does not have an account with the online service provider 130 (e.g., if the second user 120 is visiting the URL for the first time), then an account may be automatically created for the second user 120 with the online service provider 130 in response to the second user 120 initiating the web-based chat session (e.g., visiting the URL for the first time). In some embodiments, an account for the second user 120 with the online service provider 130 may be automatically created in response to the second user 120 causing the URL to be loaded on a web browser on the second communication device 125. In some embodiments, automatically creating the account for the second user 120 may comprise obtaining the second user's name from an electronic address book of the first user 110. In some embodiments, the initial SMS message 140 in FIG. 1A may be sent to a mobile phone number of the second user 120, and automatically creating the account for the second user 120 may comprise using the mobile phone number of the second user 120 in creating the account for the second user 120.

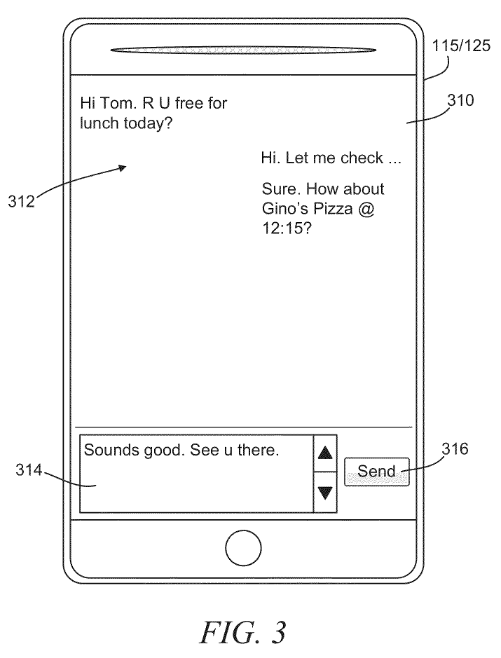

In some embodiments, a user interface may be used by the first user 110 and the second user 120 to exchange SMS messages and web-based chat messages of the initiated chat session. FIG. 3 illustrates a user interface 310 for a web-based chat session, in accordance with some embodiments. This user interface 310 may be displayed on the first communication device 115 and/or the second communication device 125. The user interface 310 may comprise a message display area 312 for displaying the messages that have already been exchanged. The messages of the first user 110 may be displayed on one side of the message display area 312, while the messages of the second user 120 may be displayed on the opposite side of the message display area 312. Other display configurations are also within the scope of the present disclosure.

In some embodiments, the messages in the message display area 312 may include all of the messages of the current chat session between the first user 110 and the second user 120, such as those messages that have been exchanged since (and including) the initial SMS message 140 from the first user 110 to the second user 120. In some embodiments, the messages in the message display area 312 may include a complete history of all of the messages exchanged between the first user 110 and the second user 120, including messages that were exchanged prior to the current chat session. For example, in response to a web-based chat session being initiated, a chat tab may be rendered on the communication devices 115, 125, and any past messages exchanged between the first user 110 and the second user 120 may be loaded in the chat tab. Other configurations are also within the scope of the present disclosure.

The user interface 310 may also comprise a message input area 314 for entering content (e.g., text, emoticons) to be transmitted to the other user, as well as a selectable submission button 316 for submitting the content in the message input area 314 for transmission to the other user.

In some embodiments, the user interface 310 may be loaded on the first communication device 115 through a mobile application (e.g., the mobile application previously discussed), and then used by the first user 110 to send the initial SMS message 140 to the second user 120. In some embodiments, the user interface 310 may be loaded on the second communication device 125 in response to the second user 120 loading the URL in the web browser on the second communication device 125. The user interface 310 may be used to send and receive both SMS messages and web-based chat messages.

In some embodiments, once the web-based chat session has been initiated, the first user 110 and the second user 120 may communicate with each other interchangeably via SMS-based communication and the web-based chat session. The first user 110 and the second user 120 may switch back and forth between using SMS-based communication and using the web-based chat session during a single conversation. The history of this conversation (e.g., any messages that have been sent and received) may be displayed in a single user interface (e.g., user interface 310 in FIG. 3) on each user's communication device.

In some embodiments, the reply path module 200 may determine the type of message of the most recent message exchanged between the first user 110 and the second user 12, and then automatically configure the next message in the conversation between the first user 110 and the second user 120 based on this determined type. For example, if the reply path module 200 determines that the most recent message was an SMS message 140 from the second user 120 to the first user 110, then the reply path module 200 may configure the next message from the first user 110 to the second user 120 to be transmitted via SMS-based communication. In some embodiments, the reply path module 200 may determine that the second user 120 visited the URL where the web-based chat session is being hosted, and automatically configure the next message from the first user 110 to the second user 120 to be transmitted via the web-based chat session based on this determination of the second user 120 visiting the URL.

In some embodiments, the user 110 or 120 can override the automatic configuration of one form of communication discussed above and choose to send the next message via the other form of communication. For example, although the first user 110 and the second user 120 may exchange chat messages 150 back and forth for a couple of rounds via the web-based chat session in FIG. 1B, during the conversation, the second user 120 may switch to sending an SMS message 140, as shown in FIG. 1C.

Upon receiving the SMS message 140 from the second user 120, the first user 110 may decide to send a reply. As a result of the most recent message exchanged between the first user 110 and the second user 120 being an SMS message, the first user's reply message may be automatically configured as an SMS message 140, as shown in FIG. 1D, thereby matching the message type of the most recent message exchanged. However, it is contemplated that the first user 110 may be enabled to override this automatic configuration and send the reply message via the web-based chat session instead.

In some embodiments, all of the SMS messages 140 sent and received by the first user 110 and/or the second user 120 may be copied to the online service provider 130. The online service provider 130 may store a history 135 of these SMS messages, along with all of the chat messages 150 as well, as shown in FIG. 1E. In some embodiments, the entire history 135, or a portion thereof, of all of the SMS messages 140 and/or chat messages 150 sent and received by the first user 110 and/or the second user 120 via the user interface 310 of the application installed on the corresponding communication device 115, 125 may be caused to be displayed to the first user 110 via the mobile application on the first device 115 and/or to the second user 120 via the URL (e.g., in the context of the web-based chat session).

In some embodiments, if one of the users (e.g., the first user 110) sends a chat message 150 to the other user (e.g., the second user 120), a determination may be made as to whether or not the other user received and/or read the chat message 150. A determination that the other user has not received/read the chat message 150 may be made based on a determination that a confirmation packet has not been sent by the other user's device via the web chat session within a predetermined amount of time. In some embodiments, a repeat message may automatically be sent via SMS-based communication to the other user in response to the determination that the other user has not read the chat message 150. This repeat message may comprise a copy of the chat message 150 not received/read by the other user. In other words, if the first user 110 sends a chat message 150 to the second user 120, but the second user 120 (for whatever reason) does not receive/read the chat message 150, then an SMS message 140 having the same message as the chat message (e.g., the same text entered by the first user 110 for the chat message 150) may be automatically sent to the second user 120. In this regard, an SMS message 140 may be used as an automatic default back-up message for a failed chat message 150.

In FIGS. 1A-1E, reference numeral 140 is used to represent an SMS message. Although the same reference numeral 140 is used in different figures, each usage refers to a distinct message. For example, the SMS message 140 in FIG. 1A is a different message than the SMS message 140 in FIGS. 1C-1E. In this respect, reference numeral is used to identify the type of message.

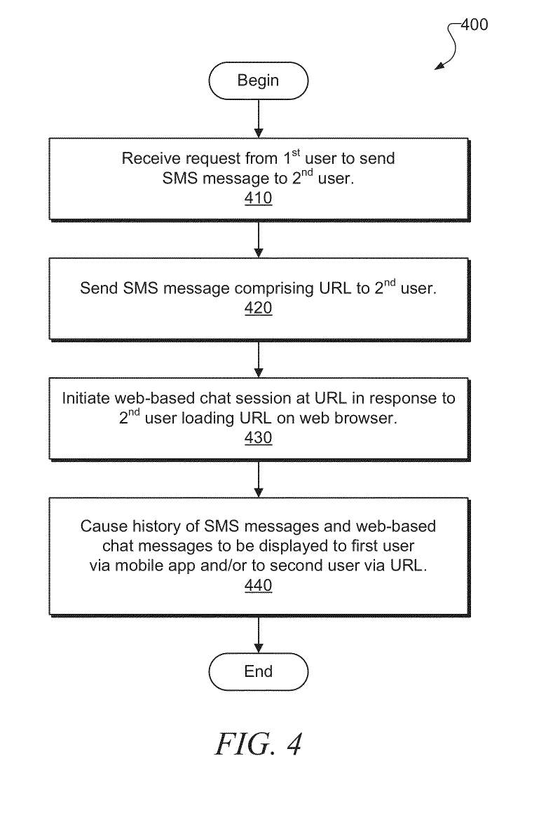

FIG. 4 is a flowchart illustrating a method 400 of providing a web reply path via SMS-based communication, in accordance with some embodiments. It is contemplated that the operations of method 400 may be performed by a system or modules of a system (e.g., reply path module 200 in FIGS. 2A-2B). At operation 410, a request is received from the first user 110 on the first device 115 to send an SMS message 140 to the second user 120 on the second device 125. In some embodiments, the first user 110 may provide the request to send the SMS message 140 to the second user 120 using a mobile application installed on the first device 115. At operation 420, an SMS message 140 is sent to the second user 120 on the second device 125 via SMS-based communication in response to the request from the first user 110. The SMS message 140 may comprise a URL. In some embodiments, the URL may comprise a session token configured to represent the second user 120 or a tuple of the first user 110 and the second user 120. At operation 430, in response to the second user 120 causing the URL to be loaded on a web browser on the second device 125, a web-based chat session between the first user 110 on the first device 115 and the second user 120 on the second device 125 may be initiated using the URL. The first user 110 and the second user 120 may be enabled to send chat messages 150 to each other via the web-based chat session using the first device 115 and the second device 125 (or some other device of the second user 120), respectively. The first user 110 may use the mobile application on the first device 115 to exchange messages via the web-based chat session, and the second user 120 may use the web browser on which the URL is loaded on the second device 125 (or some other device of the second user 120) to exchange messages via the web-based chat session. The web-based chat session may be hosted by the online service provider 130 at the URL. In some embodiments, the second user 120 may cause the URL to be loaded by selecting a link to the URL in the SMS message 140 or by entering the URL into the web browser on the second device 125. At operation 440, a history 135, or a portion thereof, of all of the SMS messages 140 and/or chat messages 150 exchanged between the first user 110 and the second user 120 via the user interface 310 of the application installed on the first communication device 115 of the first user 110 may be caused to be displayed within the mobile application to the first user 110 and/or via the URL (e.g., in the context of the web-based chat session) to the second user 120. It is contemplated that any of the other features described within the present disclosure may be incorporated into method 400.

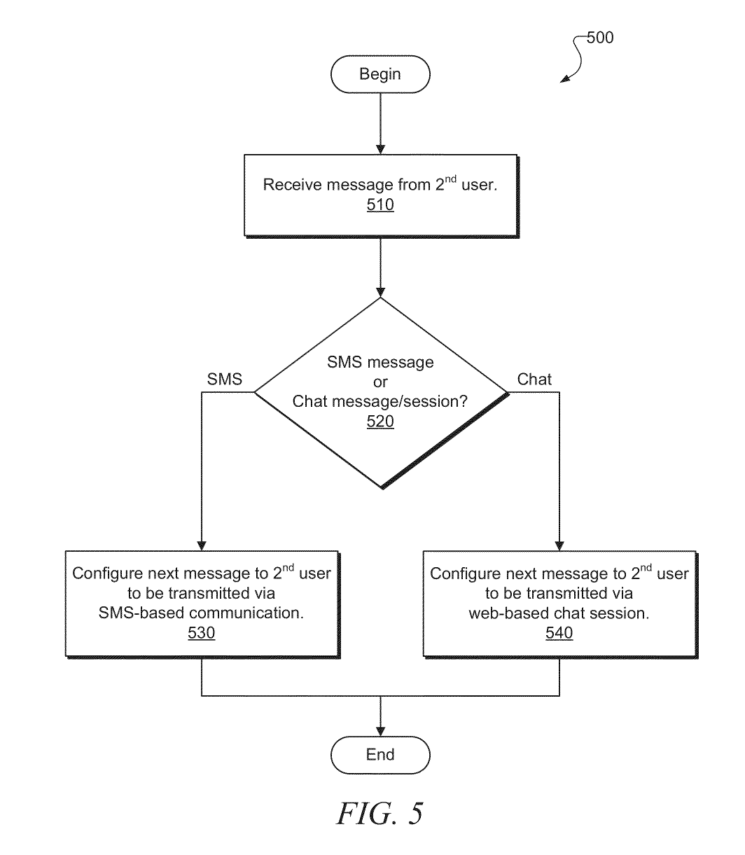

FIG. 5 is a flowchart illustrating a method 500 of switching between SMS-based communication and a web-based chat session, in accordance with some embodiments. It is contemplated that the operations of method 500 may be performed by a system or modules of a system (e.g., reply path module 200 in FIGS. 2A-2B). At operation 510, a message may be received from the second user 120. At operation 520, it may be determined whether the received message is an SMS message 140 or a chat message 150. If it is determined that the received message is an SMS message 140, then, at operation 530, the next reply message to the second user 120 may be automatically configured to be transmitted via SMS-based communication. The method 500 may then come to an end. If, at operation 520, it is determined that the received message is a chat message 150 sent via the web-based chat session, then, at operation 540, the next reply message to the second user 120 may be automatically configured to be transmitted via the web-based chat session. Additionally or alternatively, at operation 520, it may be determined whether the second user 120 has visited the URL and caused the initiation of the web-based chat session. If it is determined that the second user 120 has visited the URL and caused the initiation of the web-based chat session, then, at operation 540, the next reply message to the second user 120 may be automatically configured to be transmitted via the web-based chat session. In some embodiments, this determination of the second user 120 visiting the URL may override a determination that the received message is an SMS message 140. For example, the second user 120 may send an SMS message 140 to the first user 110, but then immediately visit the URL, thereby causing the web-based chat session to be initiated. In this scenario, even though the message received by the first user 110 will be an SMS message 140, the next reply message to the second user 120 may be automatically configured to be transmitted via the web-based chat session based on the detection of the web-based chat session being initiated. The method 500 may then come to an end. It is contemplated that any of the other features described within the present disclosure may be incorporated into method 500.

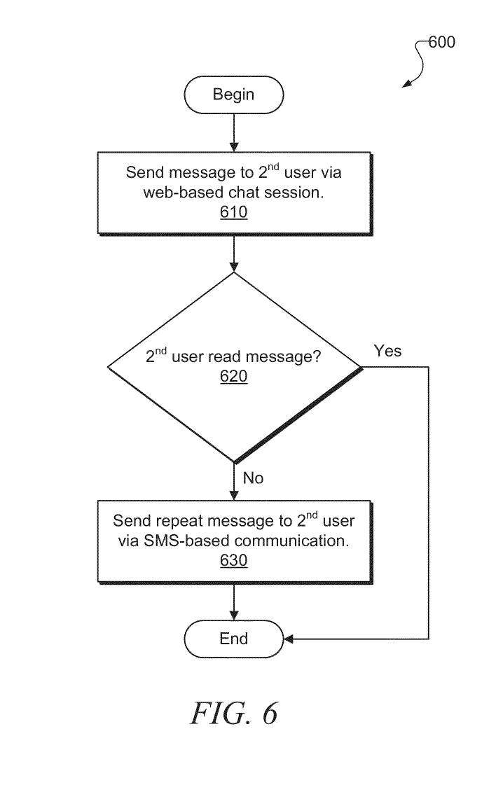

FIG. 6 is a flowchart illustrating another method 600 of switching between SMS-based communication and a web-based chat session, in accordance with some embodiments. It is contemplated that the operations of method 600 may be performed by a system or modules of a system (e.g., reply path module 200 in FIGS. 2A-2B). At operation 610, a chat message 150 is sent to the second user 120 via the web-based chat session. At operation 620, it is determined whether or not the second user 120 has read the chat message 150. As previously discussed, such determination may be based on whether or not a confirmation packet has been received within the predetermined amount of time. If it is determined that the second user 120 has read the chat message 150, then the method 600 may come to an end. If it is determined that the second user 120 has not read the chat message 150, then, at operation 630, a repeat message may be sent to the second user 120 via SMS-based communication. This repeat message may comprise a copy of the chat message 150. It is contemplated that any of the other features described within the present disclosure may be incorporated into method 600.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 410 of FIGS. 4-7B) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

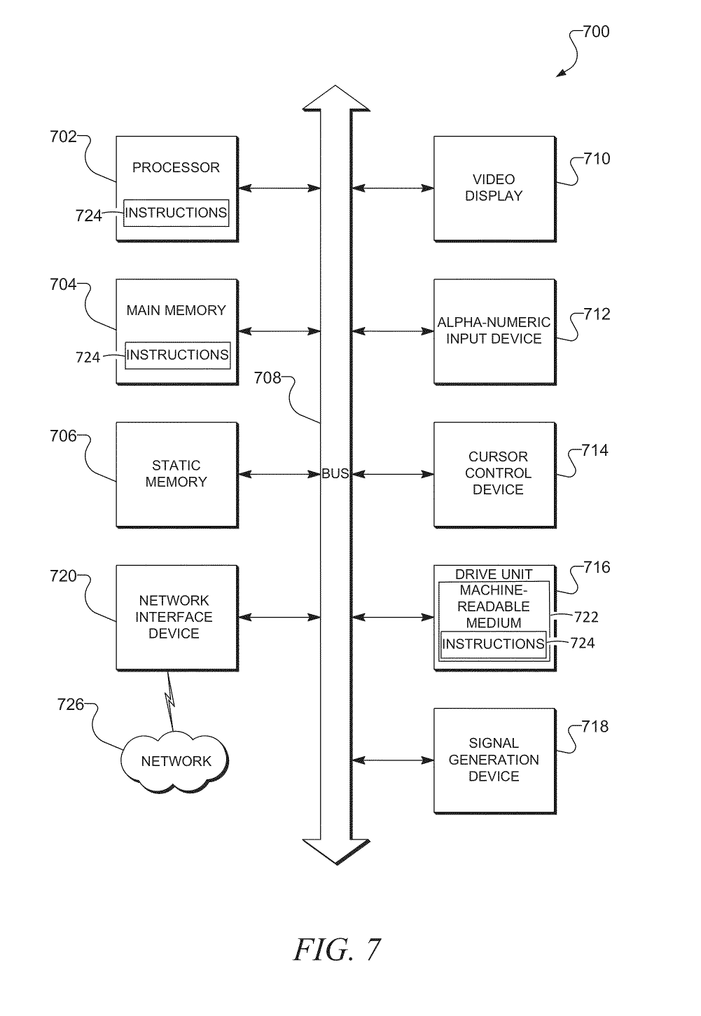

FIG. 7 is a block diagram of a machine in the example form of a computer system 700 within which instructions 724 for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a user interface (UI) navigation (or cursor control) device 714 (e.g., a mouse), a disk drive unit 716, a signal generation device 718 (e.g., a speaker) and a network interface device 720.

### Machine-Readable Medium

The disk drive unit 716 includes a machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704 and/or within the processor 702 during execution thereof by the computer system 700, the main memory 704 and the processor 702 also constituting machine-readable media. The instructions 724 may also reside, completely or at least partially, within the static memory 706.

While the machine-readable medium 722 is shown in an example embodiment to be a single medium, the term “machine-readable medium” may include a single medium or multiple media (e.g., a centralized or distributed database, and/or associated caches and servers) that store the one or more instructions 724 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 724 may further be transmitted or received over a communications network 726 using a transmission medium. The instructions 724 may be transmitted using the network interface device 720 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
receiving, from a first user on a first device, a request to send a short message service (SMS) message to a second user on a second device;
sending a first SMS message to the second user on the second device via SMS-based communication in response to the request from the first user, the first SMS message comprising a uniform resource locator (URL); and
in response to the second user causing the URL to be loaded on a web browser, initiating, by a machine having a memory and at least one processor, a web-based chat session between the first user and the second user using the URL, the first user and the second user being enabled to send chat messages to each other via the web-based chat session, the web-based chat session being hosted by an online service provider at the URL.

2. The method of claim 1, wherein the second user causing the URL to be loaded comprises the second user selecting a link to the URL in the first SMS message or the second user entering the URL into the web browser.

3. The method of claim 1, further comprising:
if it is determined that a last message from the second user to the first user was sent via SMS-based communication, then configuring a first next message from the first user to the second user to be transmitted via SMS-based communication.

4. The method of claim 1, further comprising:
if it is determined that the second user visited the URL, then configuring a second next message from the first user to the second user to be transmitted via the web-based chat session.

5. The method of claim 1, further comprising:
determining that the second user has not read a web chat message transmitted via the web-based chat session based on a confirmation packet not being sent by the second device via the web chat session within a predetermined amount of time; and
automatically sending a repeat message via SMS-based communication to the second user in response to the determination that the second user has not read the web chat message.

6. The method of claim 5, wherein the repeat message comprises a copy of the web chat message.

7. The method of claim 1, wherein the first user provides the request to send the SMS message to the second user using a mobile application installed on the first device, the mobile application providing a user interface for sending the first SMS message to the second user and for sending and receiving the chat messages of the web-based chat session with the second user.

8. The method of claim 7, further comprising:
receiving a second SMS message from the second user as a reply to the first SMS message from the first user;
displaying the second SMS message to the first user via the user interface of the mobile application on the first device;
creating a third SMS message via the user interface of the mobile application on the first device; and
sending the third SMS message to the second user via SMS-based communication.

9. The method of claim 7, wherein the mobile application sends a copy of all SMS messages sent and received by the first user to the online service provider.

10. The method of claim 1, further comprising causing a history of SMS messages and chat messages exchanged between the first user and the second user to be displayed to the second user via the URL.

11. The method of claim 1, further comprising, in response to receiving the request from the first user, creating or receiving a session token configured to represent the second user, and including the session token in the URL in the first SMS message, wherein the session token is used to initiate the web-based chat session between the first user and the second user.

12. The method of claim 1, wherein the first SMS message is sent to the second user via a wireless carrier used by the first user or an SMS gateway of the online service provider.

13. The method of claim 1, further comprising automatically creating an account for the second user with the online service provider in response to the second user causing the URL to be loaded on the web browser.

14. The method of claim 13, wherein automatically creating the account for the second user comprises obtaining the second user's name from an electronic address book of the first user.

15. The method of claim 13, wherein:
the first SMS message is sent to a mobile phone number of the second user; and
automatically creating the account for the second user comprises using the mobile phone number of the second user in creating the account for the second user.

16. A system comprising:
a machine having a memory and at least one processor; and
a reply path module, executable by the machine, configured to:
receive, from a first user on a first device, a request to send a short message service (SMS) message to a second user on a second device;
send a first SMS message to the second user on the second device via SMS-based communication in response to the request from the first user, the first SMS message comprising a uniform resource locator (URL);
in response to the second user causing the URL to be loaded on a web browser, initiate a web-based chat session between the first user and the second user using the URL, the first user and the second user being enabled to send chat messages to each other via the web-based chat session, the web-based chat session being hosted by an online service provider at the URL; and
cause a history of SMS messages and chat messages exchanged between the first user and the second user to be displayed to the second user via the URL.

17. The system of claim 16, wherein the second user causing the URL to be loaded comprises the second user selecting a link to the URL in the first SMS message or the second user entering the URL into the web browser on the second device.

18. The system of claim 16, further comprising:
if it is determined that a last message from the second user to the first user was sent via SMS-based communication, then configuring a first next message from the first user to the second user to be transmitted via SMS-based communication.

19. The system of claim 16, further comprising:
if it is determined that the second user visited the URL, then configuring a second next message from the first user to the second user to be transmitted via the web-based chat session.

20. A non-transitory machine-readable storage medium comprising instructions that, when executed by at least one processor of a machine, cause the machine to perform a set of operations comprising:
receiving, from a first user on a first device, a request to send a short message service (SMS) message to a second user on a second device;
in response to receiving the request from the first user, creating or receiving a session token configured to authenticate the second user, wherein the session token is used to initiate the web-based chat session between the first user and the second user
sending a first SMS message to the second user on the second device via SMS-based communication in response to the request from the first user, the first SMS message comprising a uniform resource locator (URL), the URL comprising the session token; and
in response to the second user causing the URL to be loaded on a web browser, initiating a web-based chat session between the first user and the second user using the URL, the first user and the second user being enabled to send chat messages to each other via the web-based chat session, the web-based chat session being hosted by an online service provider at the URL.
